(19) United States
(12) Patent Application Publication
(10) Pub. No.: US 2012/0175316 A1
(43) Pub. Date: Jul. 12, 2012

(54) METHOD FOR EXTRACTING AT LEAST ONE CHEMICAL ELEMENT FROM A MOLTEN SALT MEDIUM

(75) Inventors: Frédéric Goettmann, Les Angles (FR); Olivier Conocar, Pujaut (FR); Agnès Grandjean, Saint Marcel de Careiret (FR); Daniel Meyer, Saint Genies de Comolas (FR); Jérôme Lacquement, Saint Laurent de Camols (FR)

(73) Assignee: Commissariat a l'energie atomique et aux energies alternatives, Paris (FR)

(21) Appl. No.: 13/384,319

(22) PCT Filed: Jul. 15, 2010
(86) PCT No.: PCT/EP2010/060245

§ 371 Date: Mar. 26, 2012

(30) Foreign Application Priority Data
Jul. 17, 2009 (FR) 09 54989

(51) Int. Cl. B01D 43/00; C08G 73/06; C08G 63/44

(52) U.S. Cl. 210/749; 528/362; 528/423

(57) ABSTRACT

A method for extracting at least one chemical element contained in a molten salt medium can include the following steps: a) putting the molten salt medium with the chemical element in contact with a monomer including at least one group able to complex the chemical element, the monomer thereby forming a coordination complex with the chemical element; and b) polymerizing the thereby complexed monomer.

TECHNICAL FIELD

The present invention relates to a method for extracting at least one chemical element in a molten salt medium, this method may have as an application the separation of at least one chemical element from at least one other chemical element present in this same medium.

In the foregoing and in the following, it is specified that by <<chemical elements>> is meant any chemical element listed in Mendeleev's Periodic Table of the Elements.

This method may be used both for separating two distinct groups of chemical elements and for separating two chemical elements belonging to a same group.

Also, it may most particularly find application in the field of reprocessing irradiated nuclear fuels, in particular for extracting certain actinides and/or fission products from a molten salt medium comprising such elements.

### STATE OF THE PRIOR ART

To this day, all the reprocessing schemes of irradiated fuels commercially utilized are based on the PUREX hydrometallurgical method (the acronym corresponding to <<Plutonium Uranium Refining by Extraction>>). In this method, the irradiated fuel is first of all dissolved in nitric acid. The resulting solution is then put into contact with an organic solvent acting as an extractant which is non-miscible with nitric acid, with which two phases are recovered at the end of this process:
an organic phase comprising the uranium and plutonium; and
an aqueous phase comprising minor actinides (such as americium and curium) and fission products, which is also called a <<PUREX raffinate>>.

The organic phase comprising the uranium and plutonium is subject to an extraction step, so as to isolate the uranium from the plutonium, which may be reused for producing fuels based on uranium and/or plutonium.

The PUREX process developed during the Second World War is now applied in industrial plants with great capacity, typically having a reprocessing throughput of the order of 1,000 t/year. It has notably benefited from many enhancements, which have made it a reliable, robust process and producing little secondary waste.

The PUREX process however has many drawbacks:
it is often considered as potentially proliferating, since it gives the possibility of obtaining a flow of pure plutonium after extraction of the organic phase;
the organic solvent used as an extractant is sensitive to irradiation, which imposes for fuels with strong combustion rates, long cooling times before reprocessing;
finally, in order to be subject to reprocessing, the fuel has to be dissolved beforehand in nitric acid, which poses a problem in the case of refractory fuels which are not soluble in nitric acid.

Alternatively, pyrochemical processes for reprocessing irradiated nuclear fuels apply high temperature separation techniques in a molten salt medium (mainly, molten chloride or molten fluoride media). They have been intensively studied in the 70s, either for the reprocessing of used fuels stemming from conventional reactors, or for on-line reprocessing of the fuel of a molten salt reactor. Indeed, molten salts (generally in the form of alkaline chlorides or fluorides) may rather easily dissolve the fuels, dedicated targets and refractory matrixes contemplated for future reactors. They apply reagents insensitive to irradiation and transparent to neutrons which give the possibility of reprocessing fuels with a strong combustion rate which have only cooled down a little, without criticality constraints. Finally, with them, it is not possible to directly obtain a flow of pure plutonium.

Other pyrochemical methods for processing fuels exist, among which mention may be made of:
electrolysis or electrorefining of actinides;
selective precipitation of actinide oxides by adding oxide ions O²⁻ into the molten salt;
extraction with a reducing liquid metal (also called selective extraction).

In the perspective i.a. of the possibility of limiting aqueous flows during the extraction of a chemical element, the authors offered to develop a novel method for extracting at least one chemical element in a molten salt medium, the extraction product of which may easily be separated from the molten salt medium and be optionally transformed in order to make it an inert compound, such as a ceramic (like an oxide ceramic, a nitride ceramic or a carbide ceramic).

### DISCUSSION OF THE INVENTION

Thus, the invention relates to a method for extracting at least one chemical element contained in a molten salt medium comprising the following steps:

a) a step for putting said molten salt medium comprising said chemical element in contact with a monomer comprising at least one group capable of complexing said chemical element, the monomer thereby forming a coordination complex with said chemical element;

b) a step for polymerizing said thereby complexed monomer.

The method set into place within the scope of this invention has the following advantages:
it allows simple extraction via a complexation phenomenon without generating any extraction aqueous flow;
it allows simple separation of the resulting complexation product after a suitable reaction (in this case a polymerization reaction) by simple physical separation.

Before going into more detail in the description, we shall specify the following definitions.

By molten salt is mean an anhydrous liquid resulting from the melting of at least one salt, for example an alkaline salt.

By complexation, is meant a reaction between the monomer and the chemical element, involving the sharing of a free doublet borne by a group of the monomer with the chemical element.

By coordination complex, is meant a polyatomic structure comprising the chemical element around which groups belonging to at least one monomer are bound through coordination bonds, the coordination bonds being generated by providing a doublet of electrons belonging to said groups in an empty orbital of the chemical element.

As mentioned above, the method of the invention comprises a step for putting said molten salt medium comprising said chemical element in contact with a monomer comprising at least one group capable of complexing said chemical element.

The monomer may comprise at least one group bearing a free doublet, in particular an amine group, which will be able to complex the chemical element to be extracted.

As examples of such monomers, mention may be made of aliphatic monomers comprising at least one amine group and one nitrile group, such as:
the cyanamide of the following formula:

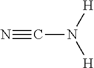

the dicyanamide of the following formula:

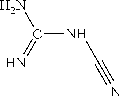

Mention may also be made of aromatic monomers comprising at least one amine group and/or one nitrile group, such as:
the melamine of the following formula:

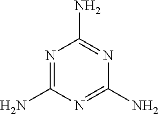

the 1,4-dicyanobenzene of the following formula:

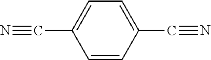

the 1,2,4,5-tetracyanobenzene of the following formula:

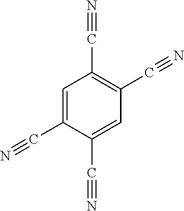

The molten salt medium comprising the chemical element to be extracted may be based on at least one alkaline salt, such as sodium chloride, lithium chloride, potassium chloride or a mixture thereof.

The molten salt medium comprising the chemical element may also be an eutectic mixture of salts such as an LiCl-KCl mixture, the advantage of such a mixture being that it has a lower melting temperature as compared with that of LiCl, KCl salts taken individually.

The method subsequently comprises a step for polymerizing the thereby complexed monomer, this polymerization step may be induced by heating the medium comprising the molten salt and the complexed monomer.

The resulting polymer thereby traps the chemical element initially complexed by the monomers.

The polymer from the polymerization step may then be subject to a step for separating the molten salt medium and optionally converted into a carbide, a nitride or an oxide.

The separation step may be carried out by filtration or centrifugation.

As an example, the method of the invention may be a method for extracting neodymium contained in a molten salt medium comprising:
a step for putting a molten salt medium comprising neodymium in contact with melamine;
a step for polymerizing the melamine complexed with the neodymium,

the molten salt medium may be an eutectic mixture comprising lithium chloride and potassium chloride, the neodymium appearing in the form of neodymium chloride.

As mentioned above, the chemical element may be any element from the periodic classification of Mendeleev. In particular, this may be a metal element, such as a transition metal, a lanthanide element such as neodymium, an actinide element or mixtures thereof.

By using monomers having groups capable of selectively complexing at least one chemical element relatively to another chemical element, the complexation method of the invention may thus be used for purposes of separation of at least one chemical element from at least one other chemical element.

Thus, the invention also relates to a method for separating at least one chemical element E1 from at least one second chemical element E2 comprising a step for applying the aforementioned extraction method, the selected monomer(s) being monomers comprising at least one group capable of selectively complexing said element E1 relatively to said element E2.

As an example, the separation method may consist in the separation of neodymium from a mixture comprising the latter and cerium, this method comprising:
a step for putting a molten salt medium comprising neodymium and cerium in contact with melamine, the melamine being capable of selectively complexing neodymium relatively to cerium;
a step for polymerizing the melamine complexed with the neodymium,

the molten salt medium may be an eutectic mixture comprising lithium chloride and potassium chloride, the neodymium appearing as neodymium chloride and the cerium as cerium chloride;
a step for separating the thereby complexed polymer from the molten salt medium.

It should be noted that neodymium(III) is not an actinide but a lanthanide which has chemical properties extremely close to that of actinides(III) (such as plutonium(III), americium(III) and curium(III)) notably in terms of solubility and complexation. The use of neodymium(III) instead of trivalent actinides in the elaboration of methods intended to be applied with these actinides, is therefore conventional.

Because the neodymium (III) may be selectively separated with the method of the invention, it may be inferred therefrom that the method of the invention may be applied to the separation of actinides, such as the minor actinides relatively to the lanthanides.

Thus, according to an embodiment, the element(s) E1 are selected from the group formed by actinide elements (such as minor actinides like americium, curium and neptunium), while the element(s) E2 are selected from the group of lanthanides, of non-lanthanide fission products.

In particular, the extraction method and the separation method of the invention may find application in the field of reprocessing of an irradiated fuel notably for ensuring separation of the actinides and of the fission products.

In this case, the extraction method or the separation method may comprise before the contacting step, a step for melting the irradiated fuel in the molten salt medium.

The extraction method and the separation method may further comprise a method for heat treatment of the polymer obtained at an effective temperature for transforming it into a ceramic, which may be a carbide, a carbonitride, a nitride (if the monomer comprises at least one nitrogen atom), this treatment may consist in heating in an inert atmosphere such as a nitrogen and/or argon atmosphere, or which may be an oxide comprising the extracted or separated elements provided that heating is carried out in air.

When the chemical elements retained in these products are actinides, such as minor actinides, they may be used as transmutation targets.

In addition to the already aforementioned advantages, the methods of the invention comprise the following advantages:
the use of reagents, in this case monomers, often inexpensive;
a simpler application than in extraction techniques such as electrorefining, reducing extraction or precipitation with provision of oxide ions.

The invention will now be described with respect to the following examples given as an illustration and not as a limitation.

### SHORT DESCRIPTION OF THE DRAWINGS

FIG. 1 is a thermogravimetric analysis (TGA) diagram obtained for the powder made according to Example 1.

FIG. 2 is an EDS diagram obtained for the powder made according to Example 1.

FIG. 3 is an EDS obtained for the powder made according to Example 3.

FIG. 4 is an XRD diagram obtained for the powder made according to Example 3.

FIG. 5 is an EDS diagram obtained for the powder made according to Example 5.

### DETAILED DISCUSSION OF PARTICULAR EMBODIMENTS

### Example 1

The reagents used within the scope of this example are the following:
LiCl (8.7 g; 0.2 mol)
KCl (11.2 g; 0.15 mol)
NdCl₃ (2.0 g; 8 mmol)
Melamine 1.4 g (11 mmol)

The salts (i.e. KCl, LiCl, NdCl₃) are intimately mixed in a mortar and then dried for 2 hours in vacuo at 120° C. The whole is then placed in a quartz crucible in a tubular oven which may be operated under a controlled atmosphere. After one night with an argon flow at room temperature, the crucible is brought to 400° C. within 1 hour, with which a molten salt mixture is obtained, appearing as a blue solution. Melamine is then added at 400° C. and the solution is then homogenized. The whole is then brought to 450° C. for 1 hour, and then at 550° C. for 4 hours, with which polymerization of the melamine is obtained.

After cooling, a block is obtained having a white surface phase and a yellow phase at the bottom of the crucible. The whole is milled and then washed with 1M nitric acid and then with water and then filtered. This powder is called hereafter Nd@C₃N₄. Atomic emission spectrometry analysis ICP-AES of the washing waters show that about 50% of the initial neodymium has been incorporated into the powder. The obtained powder was characterized with different techniques: thermogravimetric analysis and X-ray spectrometry with energy dispersion (so called EDS).

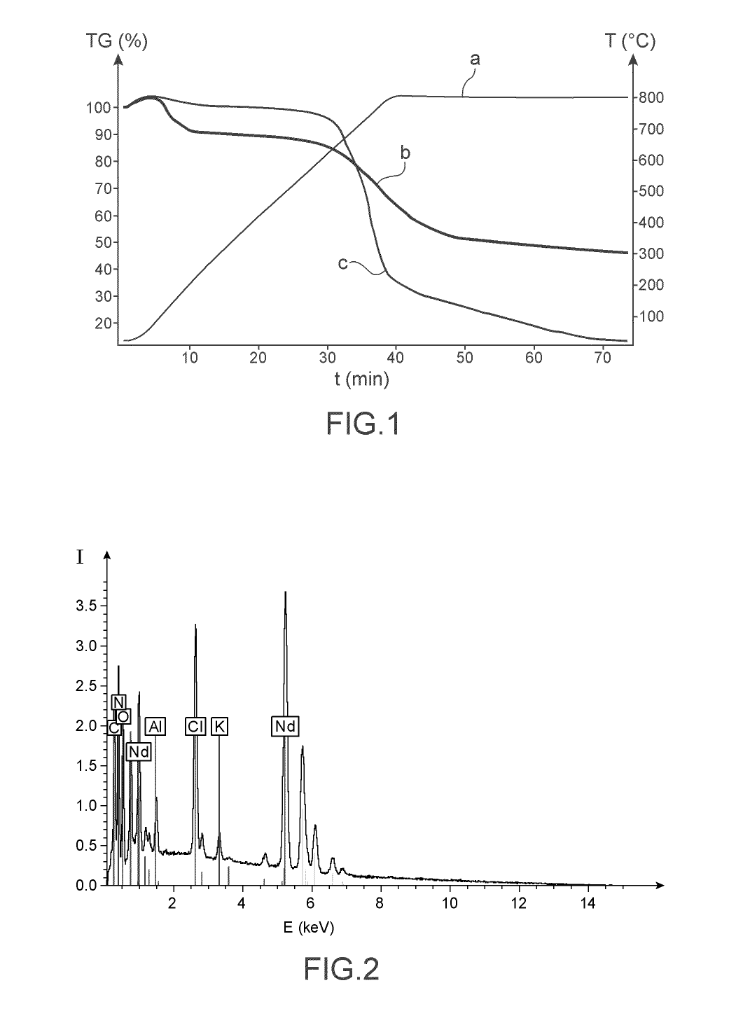

The results of the thermogravimetric analysis appear on the diagram illustrated in FIG. 1 illustrating on the first ordinate scale, the time-dependent change in the mass of the TG powder (in %), on the second ordinate scale, the temperature T (in ° C.) and on the abscissa scale, the time t (in mins).

The curve (a) illustrates the heat treatment which was applied to the Nd@C₃N₄ powder prepared according to the operating procedure discussed above and to a C₃N₄ powder prepared according to an operating procedure similar to the one discussed above, except that it is not proceeded with the addition of a neodymium salt. The heat treatment consists of raising the temperature up to 800° C. for 40 minutes followed by maintaining this temperature at 800° C. for 30 minutes.

The curve (b) illustrates the time-dependent change in the TG mass loss (in %) of the Nd@C₃N₄ powder during the aforementioned heat treatment. It is observed that after 30 minutes at 800° C., there remains a significant residual mass relatively to the synthesized powder without neodymium C₃N₄, which is totally decomposed under the same conditions (as confirmed by curve (c) illustrating the TG mass loss (in % of the C₃N₄ powder during the aforementioned heat treatment).

The results of energy dispersion X-ray spectrometry (so called EDS) are transferred onto FIG. 2, (the abscissae representing the energy (in keV)) carried out with the Nd@C₃N₄ powder, allow identification of neodymium.

The elementary analysis was carried out with the Nd@C₃N₄ powder and with the reference powder C₃N₄. It clearly emerges from the table below that the obtained powders comprise about 20% by mass of neodymium.

| | C₃N₄ | C₃N₄ | Nd@C₃N₄ | Nd@C₃N₄ |
|---|---|---|---|---|
| Elements | Mass % | Molar ratio | Mass % | Molar ratio |
| C | 27.6 | 6.0 | 19.0 | 6.0 |
| H | 1.1 | 2.9 | 1.8 | 6.8 |
| N | 46.5 | 8.7 | 31.9 | 8.6 |
| Nd | — | — | 20.1 | 0.5 |
| Cl | 8.9 | 0.7 | 5.9 | 0.6 |
| Li | 4.3 | 1.6 | 0.5 | 0.6 |
| K | 2.2 | 0.1 | 0.4 | 0.0 |
| C/N | — | 0.69 | — | 0.69 |

### Example 2

The reagents used within the scope of this example are the following:
LiCl (8.7 g; 0.2 mol)
KCl (11.2 g; 0.15 mol)
NdCl₃ (2.0 g; 8 mmol)
Melamine 1.4 g (11 mmol)

The salts (i.e. KCl, LiCl, NdCl₃) are intimately mixed in a mortar and then dried for 24 hours in an oven at 120° C. The whole is then brought to 400° C. for 1 hour in a crucible in alumina placed in a muffle oven (i.e. without any control of the atmosphere), with which a molten salt mixture is obtained, appearing as a blue solution. The melamine is then added at 400° C. and the solution is then homogenized. The whole is then brought to 450° C. for one hour, and then to 550° C. for 4 hours.

After cooling, a block comprising a white surface phase and a yellow phase at the bottom of the crucible is obtained. The whole is milled and then washed with 1M nitric acid and with water and then filtered. The obtained powder has the same characteristics as those obtained in Example 1.

### Example 3

This example relates to the conversion of the Nd@C₃N₄ powder prepared according to Example 1 into neodymium oxide Nd₂O₃.

To do this, 1 g of Nd@C₃N₄ is heated in air at 800° C. for 4 hours. The resulting powder is slightly violet.

Analyses by energy dispersion X-ray spectrometry (so-called EDS) and X-ray diffraction (so-called XRD) spectrometry confirm that this is actually neodymium oxide Nd₂O₃.

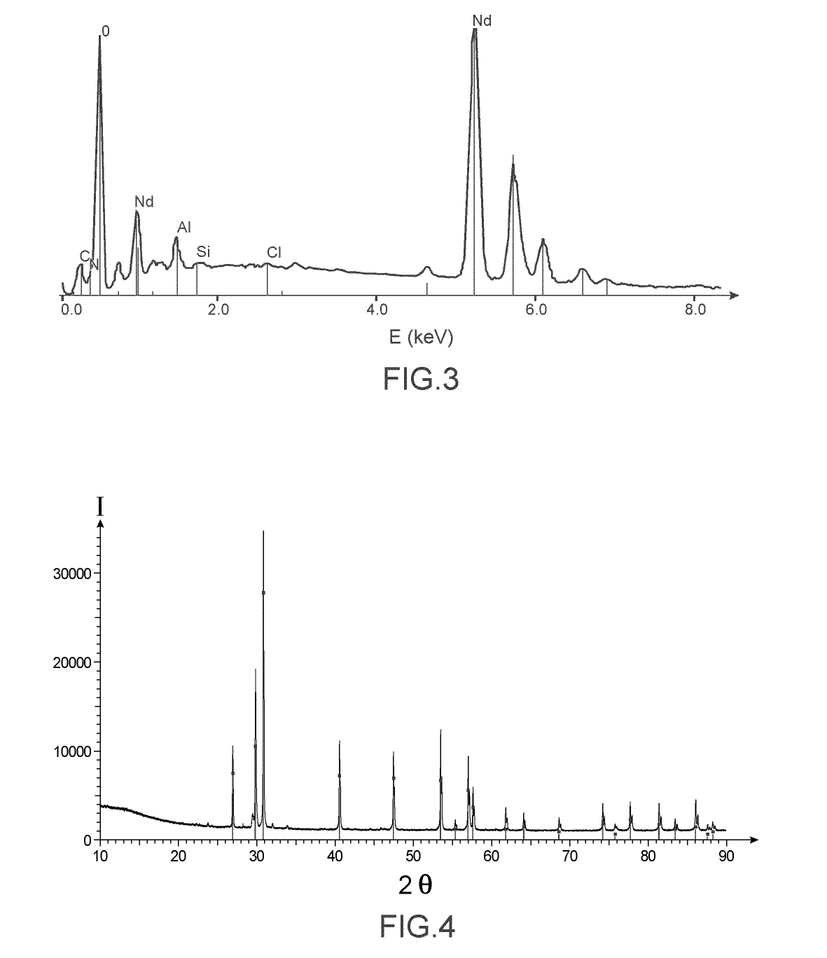

Indeed, the EDS spectrum illustrated in FIG. 3 (the abscissae representing the energy (in keV)) significantly shows that fluorescence bands correspond to neodymium and to oxygen.

As for the X-ray diffractogram illustrated in FIG. 4 (the ordinates representing the intensity of the peaks I and the abscissae the angle 2θ), it corresponds to the reference diffractogram of Nd₂O₃.

### Example 4

This example relates to the conversion of Nd@C₃N₄ powder prepared according to Example 1 into neodymium carbide Nd₂C₃.

To do this, 1 g of Nd@C₃N₄ is heated in air at 800° C. for 4 hours.

The obtained powder has an X-ray diffractogram typical of Nd₂C₃.

### Example 5

This example aims at demonstrating selective extraction of neodymium from a mixture of metal chlorides.

The reagents used within the scope of this example are the following:
LiCl (8.7 g; 0.2 mol)
KCl (11.2 g; 0.15 mol)
NdCl₃ (2.0 g; 8 mmol)
CeCl₃ (2.6 g; 10 mmol)
Melamine 1.4 g (11 mmol)

The salts (i.e. KCl, LiCl, NdCl₃ and CeCl₃) are intimately mixed in a mortar and then dried for 24 hours in an oven at 120° C. The whole is then brought to 450° C. for 1 hour in an alumina crucible, with which a mixture of molten salt is obtained appearing as a blue solution. Melamine is then added at 450° C. and the solution is then homogenized. The whole is then brought to 450° C. for 1 hour, and then to 550° C. for 4 hours.

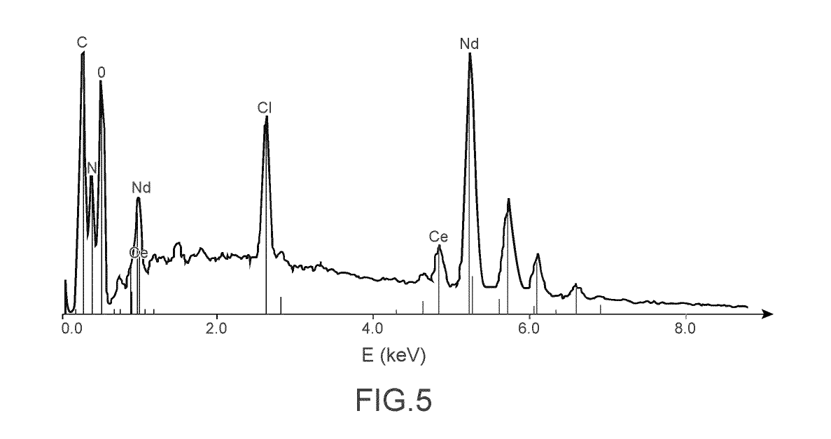

After cooling, a block is obtained having a white surface phase and a yellow phase at the bottom of the crucible. The whole is milled and then washed with 1M nitric acid and with water and then filtered. The obtained powder has the same characteristics as those obtained in Example 1, which confirms selective extraction of neodymium with respect to cerium. In particular, the EDS diagram (the abscissae representing the energy E (in keV)) illustrated in FIG. 5 shows that neodymium is in great excess relatively to cerium.

1. A method for extracting at least one chemical element contained in a molten salt medium comprising:
a) putting said molten salt medium comprising said chemical element in contact with a monomer comprising at least one group able to complex said chemical element, the monomer thereby forming a coordination complex with said chemical element;
b) polymerizing said thereby complexed monomer.

2. The method according to claim 1, wherein the monomer comprises at least one group bearing a free doublet.

3. The method according to claim 1, wherein the monomer is an aliphatic monomer comprising at least one amine group and one nitrile group.

4. The method according to claim 3, wherein the monomer is selected from the group consisting of:
cyanamide of the following formula: 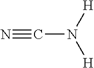
dicyanamide of the following formula:

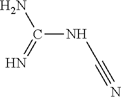

5. The method according to claim 1 wherein the monomer is an aromatic monomer comprising at least one amine group and/or one nitrile group.

6. The method according to claim 5, wherein the aromatic monomer is selected from the group consisting of:
melamine of the following formula: 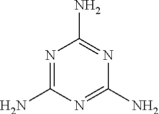
1,4-dicyanobenzene of the following formula: 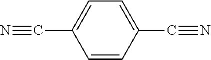
1,2,4,5-tetracyanobenzene of the following formula:

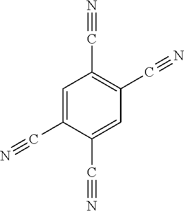

7. The method according to claim 1, wherein the monomer is melamine.

8. The method according to claim 1, wherein the molten salt medium is based on at least one alkaline salt.

9. The method according to claim 1, wherein the molten salt medium is an alkaline salt selected from the group consisting of sodium chloride, lithium chloride, potassium chloride and mixtures thereof.

10. The method according to claim 1, wherein the molten salt medium is an eutectic mixture.

11. The method according to claim 1, comprising:
putting a molten salt medium comprising neodymium in contact with melamine;
polymerizing the melamine complexed with the neodymium,
the medium may be an eutectic mixture comprising lithium chloride and potassium chloride, the neodymium appearing as neodymium chloride.

12. The method according to claim 1, wherein the chemical element is a metal element, a lanthanide element and/or an actinide element.

13. The method according to claim 1, further comprising, b), separating the molten salt medium from the polymer resulting from b).

14. The method according to claim 1, further comprising heat-treating the polymer obtained at b) at an effective temperature for transforming it into a ceramic.

15. A method for separating at least one first chemical element E1 from at least one second chemical element E2 comprising applying the extraction method as defined according to claim 1, the selective monomer(s) being monomers comprising at least one group able to selectively complex said element E1 with respect to said element E2.

16. The method according to claim 15, wherein said at least one first chemical element E1 comprises neodymium and said at least one second chemical element E2 comprises cerium, this method comprising:
putting a molten salt medium comprising neodymium and cerium in contact with melamine, the melamine being able to selectively complex the neodymium with respect to the cerium;
polymerizing the melamine complexed with the neodymium,
wherein the molten salt medium may be an eutectic mixture comprising lithium chloride and potassium chloride, the neodymium appearing as neodymium chloride and the cerium as cerium chloride;
a step for separating the thereby complexed polymer from the molten salt medium.

17. The method according to claim 1, wherein the molten salt medium is a LiCl-KCl mixture.

18. The method according to claim 1, wherein at least two chemical elements comprising a first chemical element and a second chemical element are contained in the molten salt medium, the method further comprises:
separating the first chemical element from the second chemical element, wherein the monomer comprises at least one group able to selectively complex said element E1 with respect to said element E2.

19. The method according claim 18, wherein the first chemical element E1 is neodymium and the second chemical element E2 is cerium, the method comprises:
putting a molten salt medium comprising neodymium and cerium in contact with melamine, the melamine being able to selectively complex the neodymium with respect to the cerium;
polymerizing the melamine complexed with the neodymium, wherein the molten salt medium may be an eutectic mixture comprising lithium chloride and potassium chloride, the neodymium appearing as neodymium chloride and the cerium as cerium chloride;
separating the thereby complexed polymer from the molten salt medium, which results in separation of neodymium from cerium.
